(19) United States
(12) Patent Application Publication
(10) Pub. No.: US 2016/0012176 A1
(43) Pub. Date: Jan. 14, 2016

(54) METHODS FOR DESIGNING PHOTONIC DEVICES

(71) Applicant: Coriant Advanced Technology, LLC, New York, NY (US)

(72) Inventors: Yang Liu, Elmhurst, NY (US); Michael J. Hochberg, New York, NY (US); Yi Zhang, Elkton, DE (US); Yangjin Ma, Brooklyn, NY (US); Ruizhi Shi, New York, NY (US)

(21) Appl. No.: 14/858,519

(22) Filed: Sep. 18, 2015

Related U.S. Application Data
(63) Continuation-in-part of application No. 14/093,263, filed on Nov. 29, 2013.
(60) Provisional application No. 61/731,502, filed on Nov. 30, 2012.

(51) Int. Cl. G06F 17/50; G02B 6/10; G02B 27/00; G02B 6/125

(52) U.S. Cl. CPC G06F 17/5081; G02B 6/125; G02B 6/107; G02B 27/0012; G06F 17/5009; G06F 17/5077

(57) ABSTRACT

A compact, low-loss and wavelength insensitive Y-junction for submicron silicon waveguides. The design was performed using FDTD and particle swarm optimization (PSO). The device was fabricated in a 248 nm CMOS line. Measured average insertion loss is 0.28±0.02 dB across an 8-inch wafer. The device footprint is less than 1.2 μm×2 μm, orders of magnitude smaller than MMI and directional couplers.

### CROSS-REFERENCE TO RELATED APPLICATIONS

This application is a continuation-in-part of and claims priority to U.S. patent application Ser. No. 14/093,263, filed Nov. 29, 2013, which claims the benefit of U.S. Provisional Application No. 61/731,502, filed Nov. 30, 2012, each of which is hereby incorporated by reference herein in its entirety.

### STATEMENT REGARDING FEDERALLY FUNDED RESEARCH OR DEVELOPMENT

This invention was made with government support under Grant No FA9550-10-1-0053 awarded by the Air Force Office of Scientific Research (AFOSR). The government has certain rights in the invention.

### FIELD OF THE INVENTION

The invention relates to optical waveguide components in general and particularly to a Y-junction for use with submicron silicon waveguides.

### BACKGROUND OF THE INVENTION

The last decade witnessed series of break-throughs in silicon photonics. Key components such as the electrically pumped laser (see, for example, R. Camacho-Aguilera, et al, “An electrically pumped germanium laser,” Opt. Express 20, 11316-11320 (2012)), the high-speed modulator (see, for example, G. T. Reed, G. Mashanovish, F. Y. Gardes and D. J. Thomson, “Silicon optical modulators,” Nat. Photonics 4, 518-526 (2010)) and the photodetector (see, for example, J. Michel, J. Liu, and L. C. Kimerling, “High-performance Ge-on-Si photodetectors,” Nat. Photonics, 4, 527-534 (2010)) have been successfully demonstrated. Foundry services are also becoming available to the community, making it easier to explore system level functionalities (see, for example, Y. Zhang, T. Baehr-Jones, R. Ding, T. Pinguet, Z. Xuan, M. Hochberg, “Silicon multi-project wafer platforms for optoelectronic system integration,” Proc. 9th IEEE Intern. Conf. GFP, 2012, and the web sites of opsisfoundry.org and epixfab.eu). The intrinsic advantage of silicon as a photonic material system is its high refractive index contrast over silicon dioxide, allowing submicron waveguides and tight bends, as well as the state-of-the-art CMOS fabrication infrastructure developed by the electronics industry. However, these two advantages do not always go in parallel. For example, a Y-junction is theoretically lossless, while this is generally not the case due to limited resolution of micro fabrication. Sharp corners favored by photonics designs usually violate the minimum feature size rule of a CMOS process, which can be easily caught by design rule checking (DRC) routines. The possible detrimental effects of this violation in fabrication includes peeling off of photoresists, shallower etch in the narrow gap, and voids in subsequent oxide cladding deposition. All the above degrade device performance and lower yield.

A Y-junction formed by circular bends with a butt waveguide in between to avoid the sharp corner has over 1 dB insertion loss. Mach-Zehnder modulators having two such Y-branches readily have more than 2 dB insertion loss in the budget, regardless of other losses from free carrier absorption and on-and-off chip light coupling, making them less competitive to their III-V counterparts. In addition, complicated integrated optical circuits cannot be built on such lossy components. Moreover, the abrupt waveguide discontinuity causes light scattering and back-reflection. Implicit resonance cavities formed by these scattering sites degrade the system spectrum response.

As one the most basic building blocks, a low loss and compact Y-junction is very important for silicon photonic circuits. Recently a number of authors have demonstrated attractive device performance for Y-junctions (see, for example, A. Sakai, T. Fukazawa, and T. Baba, “Low loss ultra-small branches in a silicon photonic wire waveguide,” IEICE Trans. Electron. E85-C, 1033-1038 (2002)), MMI couplers (see, for example, D. Van Thourhout, W. Bogaerts, P. Dumon, G. Roelkens, J. Van Campenhout, R. Baets, “Functional silicon wire waveguides,” Proc. Integrated Photonics Research and Applications (2006)), cascaded splitters (see, for example, Z. Wang, Z. Fan, J. Xia, S. Chen and J. Yu, “1×8 cascaded multimode interference splitter in silicon-on-insulator,” Jpn. J. Appl. Phys. 43, 5085-5087 (2004) and S. H. Tao, Q. Fang, J. F. Song, M. B. Yu, G. Q. Lo, and D. L. Kwong, “Cascaded wide-angle Y-junction 1×16 power splitter based on silicon wire waveguides on silicon-on-insulator,” Opt. Express 16, 21456-21461 (2008)), photonic crystal 3 dB couplers (see, for example, L. H. Frandsen, et al, “Ultralow-loss 3 dB photonic crystal waveguide splitter,” Opt. Lett. 29, 1623-1625 (2004)) and directional couplers (see, for example, H. Yamada, T. Chu, S. Ishida, and Y. Arakawa, “Optical directional coupler based on Si-wire waveguides,” IEEE Photonics Technol. Lett. 17, 585-587 (2005)). However, a Y-junction with low excess loss, low wavelength sensitivity, small footprint, and dimensions clearly within the typical design rules of a modern CMOS photonics process has remained elusive.

The 1×3 power splitter function can be achieved by multi-mode interference (MMI) couplers or directional couplers. Usually these devices have large insertion loss, large footprint, high wavelength sensitivity or low compatibility with CMOS fabrication methods.

There is a need for an efficient Y-junction device that can be manufactured easily.

### SUMMARY OF THE INVENTION

According to one aspect, the invention features a 1×2 power splitter for use in submicron silicon waveguides. The 1×2 power splitter comprises an input port configured to receive an optical signal having a power of substantially P watts; and a pair of output ports configured to provide substantially equal output signals each having a power of substantially P/2 Watts; the 1×2 power splitter having a footprint of less than 1.2 μm×2 μm in area.

In one embodiment, the input port has a taper width of 0.5 μm.

In another embodiment, at least one of the output ports has taper width of 0.5 μm.

In yet another embodiment, the 1×2 power splitter has a total output width of 1.2 μm.

In still another embodiment, the 1×2 power splitter has a minimum feature size of 200 nm.

In a further embodiment, the 1×2 power splitter is configured to be manufactured using a CMOS fabrication process.

In yet a further embodiment, the CMOS fabrication process is a process conducted using a 248 nm stepper.

In an additional embodiment, the CMOS fabrication process is a process conducted using a 193 nm stepper.

According to a further aspect, the invention features a method of designing a photonic device, the method comprising: identifying fabrication design rules of a fabrication process; generating an initial device design by determining, with use of constraints of the fabrication design rules, a plurality of I/O ports and segments along a direction of optical signal propagation, each segment of the plurality of segments characterized by at least one width, at least one of the segments characterized by at least two widths; and iteratively optimizing a device design starting with the initial device design by: generating a smoothed geometry of the device design; simulating a functionality of the device utilizing the smoothed geometry of the device design; and utilizing an optimization algorithm on said widths characterizing said segments.

In some embodiments a first width of each of the at least two widths defines a width of a core material, and a second width of each of the at least two widths defines a width of a material surrounding the core material. In some embodiments generating the smoothed geometry of the device design comprises spline interpolation applied to geometries of each of the two materials. In some embodiments generating the smoothed geometry of the device design comprises performing at least one of optical proximity correction and device fabrication simulation.

According to yet another aspect, the invention features a method of designing a photonic device, the method comprising: identifying fabrication design rules of a fabrication process; generating an initial device design by determining, with use of constraints of the fabrication design rules, a plurality of I/O ports and segments along a direction of optical signal propagation, each segment of the plurality of segments characterized by at least one width; and iteratively optimizing a device design starting with the initial device design by: generating a smoothed geometry of the device design with use of at least one of optical proximity correction and device fabrication simulation; simulating a functionality of the device utilizing the smoothed geometry of the device design; and utilizing an optimization algorithm on said widths characterizing said segments.

In some embodiments generating the smoothed geometry of the device design comprises spline interpolation. In some embodiments iteratively optimizing the device design is performed in accordance with the fabrication design rules. In some embodiments the fabrication design rules comprise a minimum feature size. In some embodiments the fabrication design rules comprise a minimum feature size substantially equal to 200 nm. In some embodiments the optimization algorithm comprises at least one of a particle swarm optimization algorithm and a genetic algorithm. In some embodiments simulating a functionality of the device comprises determining at least one figure of merit (FOM), wherein iteratively optimizing the device design comprises evaluating optimization criteria with use of the at least one FOM, and for each iteration of said iteratively optimizing for which optimization criteria has not been met, modifying at least one of said widths characterizing said segments according to the optimization algorithm. In some embodiments simulating a functionality of the device comprises simulating the electromagnetic response of the device using at least one of a finite difference time domain (FDTD) method, beam propagation, and eigenmode expansion.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is a schematic diagram of the device layout.

FIG. 1B is a diagram showing the contour plot of the simulated electric field intensity distribution at 1550 nm wavelength.

FIG. 2A is a graph showing the simulated power transmission as a function of wavelength.

FIG. 2B is a graph showing the simulated reflection as a function of wavelength.

FIG. 3A is a diagram showing the Y-junction characterization structure for a plurality of cascaded Mach-Zehnder structures to measure insertion loss.

FIG. 3B is a diagram showing the Y-junction characterization structure for a single Y-junction to measure coupling ratio and spectrum response.

FIG. 4A is a graph showing the typical measured spectra of the test structure in FIG. 3A for different numbers of cascaded Mach-Zehnders.

FIG. 4B is a graph showing the typical measured spectra of the test structure in FIG. 3B.

FIG. 5A is a graph of power loss as a function of the number of Y-junctions in a cascade. The dots are measured peak optical power from test structure in shown FIG. 3A on Die (0,0). The line is a linear fitting curve.

FIG. 5B is a plot of the measured cross-wafer insertion loss of Y-junctions.

FIG. 6 is a flowchart of the method used to design and fabricate photonic devices such as the Y-junction described herein.

FIG. 7A is a schematic diagram of a device layout in which device segments include multiple defined widths.

FIG. 7B is a schematic diagram of a device layout such as that depicted in FIG. 7A after its geometry has been smoothed.

### DETAILED DESCRIPTION

We have designed a compact, low-loss and wavelength insensitive Y-junction for submicron silicon waveguide using FDTD and particle swarm optimization (PSO), and fabricated the device in a 248 nm CMOS line. We have measured an average insertion loss of 0.28±0.02 dB across an 8-inch wafer. The device footprint is less than 1.2 μm×2 μm, orders of magnitude smaller than MMI and directional couplers. The function of the invention is to provide a 1×2 power splitter for submicron silicon waveguides.

Our device has very low loss, small footprint, low wavelength sensitivity and was successfully fabricated by 248 nm CMOS with good cross-wafer uniformity.

The device can be part of a more complicated optoelectronic device, such as a Mach-Zehnder modulator, or a basic building block of integrated silicon photonic circuit.

The device can be a useful component of the process design kit (PDK) of a silicon photonics foundry. Companies commercializing silicon photonics technology, such as modulators and transceivers can also integrate this device in their products.

The device achieves low loss, compact, and wavelength insensitive 1×2 power splitting for submicron silicon waveguides. It interfaces with 500 nm×200 nm silicon waveguide. The power splitter can be readily inserted into other silicon photonic device or circuits as a basic building block. It can be used as a standard GDS cell, similar to p-cells in electronic circuit, such as transistors and resistors.

We modeled the electro-magnetic response of the structure using finite difference time domain (FDTD) method, and optimized the device geometry using particle swarm simulation (PSO).

We have designed and fabricated a Y-junction for submicron silicon waveguide with a taper less than 1.2 μm×2 μm, and cross-wafer average insertion loss 0.28±0.02 dB, comparable to the result demonstrated by electron beam lithography (EBL) and MMIs with much larger footprint. The coupling ratio is wavelength insensitive. The device has a minimum feature size of 200 nm, and successfully fabricated using 248 nm lithography.

### Design and Fabrication

### Design and Optimization

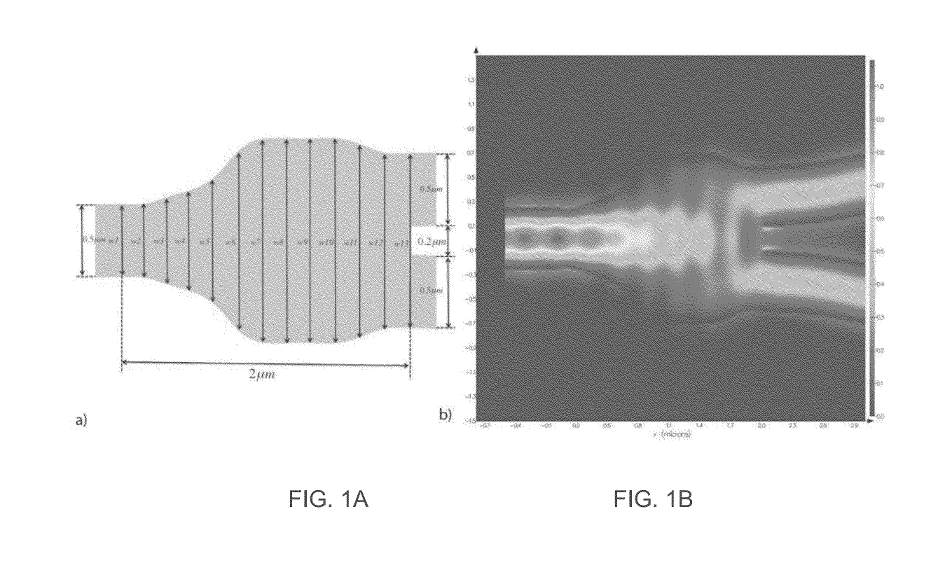

The goal was to design a compact, low loss and wavelength insensitive Y-junction for submicron silicon waveguide, compatible with typical CMOS photonic processes, where 193 nm or 248 nm steppers are commonly used. A minimum feature size of 200 nm was assumed during the design, which will not break the designs rules, thus ensure yield. Silicon waveguide geometry is 500 nm×220 nm. So the taper width is 0.5 μm at input and 1.2 μm at output, as shown in FIG. 1A. The length of the taper connecting input and output waveguides was set to 2 μm to keep the device compact. The size of Ge-on-Si photodetectors is usually on the order of 10 μm, and p-n junction modulator with phase shifter length of 50 μm has been demonstrated (see, for example, H. C. Nguyen, S. Hashimoto, M. Shinkawa and T. Baba, “Compact and fast photonic crystal silicon optical modulators,” Opt. Express 20, 22465-22474 (2012)). A simple passive component like Y-junction should be compact enough to be part of a more complicated active device or an integrated optical circuit. The Y-junction is symmetric in the propagation direction to ensure balanced output at two branches.

The electromagnetic response of dielectric structures of size on the order of wavelength of interest can be simulated by Finite Difference Time Domain (FDTD) method. FDTD can be coupled with optimization algorithms to for design optimization. Sanchis et al. demonstrated a waveguide crossing with 0.2 dB insertion loss and −40 dB cross-talk designed by FDTD and Genetic Algorithm (GA) (see, for example, P. Sanchis, et al, “Highly efficient crossing structure for silicon-on-insulator waveguides,” Opt. Lett. 34, 2760-2762 (2009)). We utilized a different optimization algorithm, Particle Swarm Optimization (PSO), in this design. PSO is initially inspired by the social behavior of flocks of birds or schools of fish (see, for example, J. Kennedy and R. Eberhart, “Particle swarm optimization,” Proc. IEEE Intern. Conf. Neural Networks (1995)), and has been successfully applied to electromagnetic optimization problems (see, for example, J. Robinson and Y. Rhamat-Samii, “Particle swarm optimization in electromagnetics,” IEEE Trans. Antennas Propag. 52, 397-407 (2004)). In PSO, the potential solutions, called particles or agents, are initialized at random positions with random velocities in the parameter space. A figure of merit function is defined to evaluate the particle position according to the optimization goal. The best position for each individual particle is recorded, as well as a global best position ever achieved by any particle in the swarm. The position of a particle is updated by the following equation,

xₙ=xₙ+Δt*vₙ (1)

vₙ=ω*vₙ+*rand( )*(p_{best,n}−xₙ)+c₂*rand( )*(g_{best,n}−xₙ) (2)

where vₙ and xₙ are particle's velocity and position in nth dimension of the parameter space, and P_{best,n} and g_{best,n} are individual and global best positions. As is apparent from Eq. 2, the new velocity is the old velocity scaled by ω and increased the direction of P_{best,n} and g_{best,n}.

ω, known as the inertial weight, is a measurement of how much a particle would like to stay at the old velocity. c₁ determines how much a particle is influenced by the memory of its best position, thus sometimes called cognitive rates. And c₂ is a factor demining how much the particle is affected by the global best position of the whole swarm, hence called social rates. The two random numbers are used to simulate the unpredictable behavior of natural swarm. It can be seen that the particle velocity is large when it is far from P_{best,n} and g_{best,n}, becomes smaller as it is closer to the best position and gets pulled back after flying over. The optimization is stopped when the figure of merit is good enough or a large number of iteration is reached.

FIG. 1A is a schematic diagram of the device layout.

FIG. 1B is a diagram showing the contour plot of the simulated electric field intensity distribution at 1550 nm wavelength.

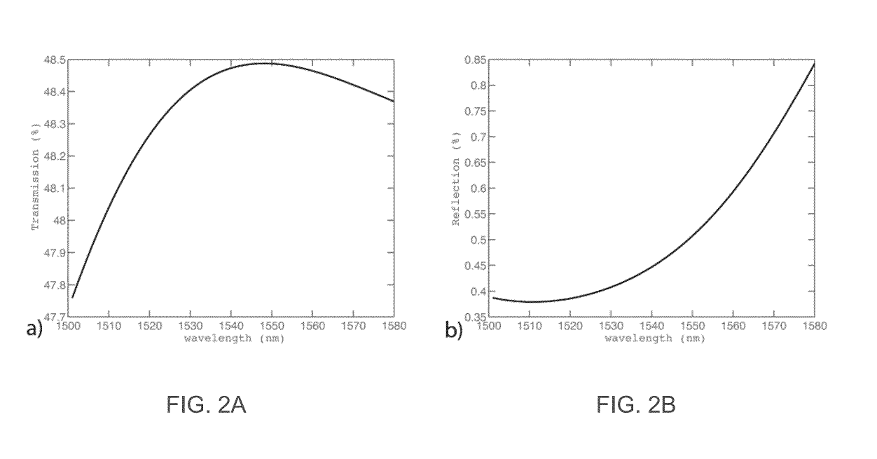

In this design, the taper was first digitalized into 13 segments of equal length. The width of each segment, labeled as w1 to w13 in FIG. 1A, was optimized to achieve low loss coupling. Taper geometry is defined by spline interpolation of these 13 points. The optimization figure of merit (FOM) was the power in TE0 mode at either branch. It was calculated by the overlap integral of TE0 mode of a 500 nm×220 nm waveguide with the detected field at the output branch. Note that it is not proper to set the total detected power to be FOM, since higher order modes will leak out of the waveguide along the way. Maximizing the power effectively reduced the scattering and back-reflection. The swarm population was set to 30. 2D FDTD was used as an approximation of 3D FDTD for computation efficiency during optimization. A commercially available code wad used (available from http://www.lumerical.com/tcad-products/fdtd/[16]. Within 50 iterations, one solution with sub-0.2 dB insertion loss emerged, as shown in Table 1. Then 3D FDTD was run on this solution to double check the result with a mesh equal to 1/34 of the free space wavelength. The insertion loss was determined to be 0.13 dB. No noticeable scattering is seen in the contour plot of electric field intensity as shown in FIG. 1b. There is an interference pattern at the input end, indicating non-zero back-reflection. Due to the root square relationship between field magnitude and optical intensity, very weak back-reflection is necessary to create clear interference patterns. The normalized transmission and reflection power as a function of wavelength is plotted in FIG. 2A and FIG. 2B. It can be seen that both the transmission and reflection are wavelength insensitive, with variation below 1% and 0.5% over wavelength range from 1500 nm to 1580 nm.

TABLE 1
Taper width in μm

| ′ | ′ | ′ | ′ | ′ | ″ | ′ | ′ | ′ | w10 | w11 | w12 |
|---|---|---|---|---|---|---|---|---|---|---|---|
| ( | ( | ( | ( | ( | 1 | 1 | 1 | 1 | 1.4 | 1.31 | 1.2 |

FIG. 2A is a graph showing the simulated power transmission as a function of wavelength.

FIG. 2B is a graph showing the simulated reflection as a function of wavelength.

### Device Fabrication

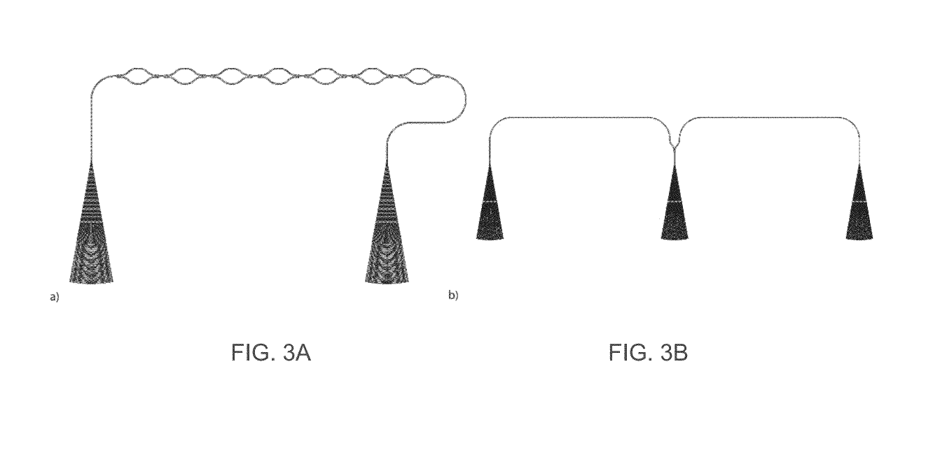

Starting substrate was an 8-inch SOI wafer, with 220 nm, 10 ohm-cm p-type top silicon film, 2 μm buried oxide on top of a silicon handle. Waveguides were patterned using 248 nm UV lithography followed by dry etching. Then a few microns of oxide were deposited as top cladding. Light coupling on and off chip was achieved by grating couplers (GC). Two kinds of characterization structures are laid out, as shown in FIG. 3A and FIG. 3B. A cascade of Mach-Zehnder structures formed by butt coupled Y-junctions were used to measure the insertion loss, similar those used in A. Mekis, et al, “A grating-coupler-enabled CMOS photonics platform,” IEEE J. Sel. Top. Quantum Electron. 17, 597-608 (2011). The other structure has the three terminals of the Y-junction connected to three grating couplers to measure the output directly. In both cases, the bend radius of waveguide is 10 μm. And grating coupler pitch is 127 μm, determined by the pitch of fiber array. Simple GC loops, i.e. two GCs connected by a U-turn waveguide, were used as a reference structure. Tiles used around the devices to achieve a certain filling ratio are not shown.

FIG. 3A is a diagram showing the Y-junction characterization structure for a plurality of cascaded Mach-Zehnder structures to measure insertion loss.

FIG. 3B is a diagram showing the Y-junction characterization structure for a single Y-junction to measure coupling ratio and spectrum response.

### Results and Discussion

### Testing Configuration

Devices were measured on a wafer scale setup that can map the wafer coordinate to the stage coordinate, so that any device can be easily probed after initial alignment. Light from a tunable laser was coupled into the device under test (DUT) via a though a polarization maintaining (PM) fiber and grating coupler, then to a photodetector through another grating coupler and PM fiber. Chuck temperature was set to 35° C., slightly higher than room temperature. The device performance reported in this paper is not expected as a strong function of temperature. Reticle size on the wafer is 2.5 cm×3.2 cm. Test structures shown in FIG. 3A and FIG. 3B in each die were tested to characterize the cross-wafer performance.

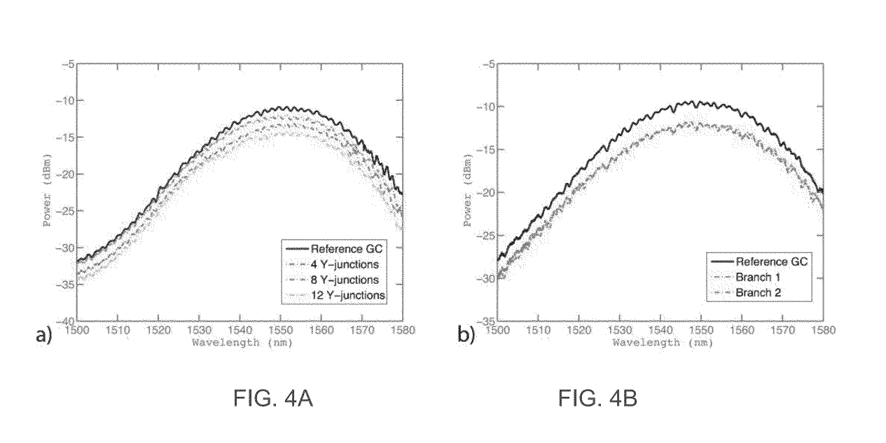

FIG. 4A is a graph showing the typical measured spectra of the test structure in FIG. 3A for different numbers of cascaded Mach-Zehnders.

FIG. 4B is a graph showing the typical measured spectra of the test structure in FIG. 3B.

Typical spectra structures in FIG. 3A and FIG. 3B are shown in FIG. 4A and FIG. 4B respectively. The parabolic-like shape is determined by the grating coupler spectrum response. The grating coupler design used here works only for TE mode and is highly polarization selective. Due to the non-perfect polarization of input light, fringes appear on the spectra. The fringes are usually 0.5 dB peak to peak, and can be reduced by using a polarization controller.

### Device Performance

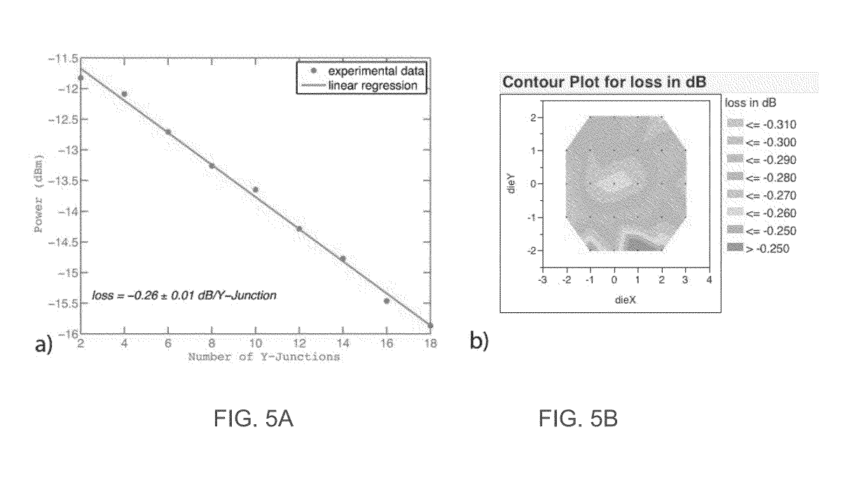

It is difficult to measure sub-0.5 dB insertion loss from a single device. Therefore, test structures with different numbers of Y-junctions in the loop were used to figure out the insertion loss. The measured peak power as a function of number of Y-junctions in the loop is plotted in FIG. 5A. Dots are test data, and the line is linear fitting. The slope of the line gives insertion loss in dB per Y-junction. Loop baseline losses, such as grating coupler insertion loss, are the same for all structures, thus won't affect the slope of the fitting line. We measured the insertion loss of all Y-junctions across the wafer.

A contour plot of insertion loss is shown in FIG. 5B. From the contour, we can see that our device performance is uniform across the wafer, with an average of 0.28±0.02 dB. Low cross-wafer variation confirms that our device is not fabrication sensitive, and can be reliable component of an integrated photonic system.

We also note that the spectra of characterization structures in FIG. 4A do not deviate from a reference GC spectrum, with only a linear offset in y-axis, even with a large number of Y-junctions in the loop. This validates our estimation that although there is an interference pattern in FIG. 1B the back-reflection is negligible and won't degrade the system spectrum response.

It is shown in S. H. Tao, Q. Fang, J. F. Song, M. B. Yu, G. Q. Lo, and D. L. Kwong, “Cascaded wide-angle Y-junction 1×16 power splitter based on silicon wire waveguides on silicon-on-insulator,” Opt. Express 16, 21456-21461 (2008) that etch residues or air voids in the gap defined by sharp corners in the layout will lead to non-uniform output at two branches of the Y-junction. In FIG. 4B, the spectra of two branches overlaps over the whole testing wavelength range, indicating balanced output power. So our design fully addressed the DRC violation issue of conventional Y-junctions.

The spectra in FIG. 4A and FIG. 4B also validate the simulation results in FIG. 2A and FIG. 2B, that the device performance is wavelength insensitive.

FIG. 5A is a graph of power loss as a function of the number of Y-junctions in a cascade. The dots are measured peak optical power from test structure in shown FIG. 3A on Die (0,0). The line is a linear fitting curve.

FIG. 5B is a plot of the measured cross-wafer insertion loss of Y-junctions.

### Design Methodology

Our result also confirms PSO as an efficient optimization algorithm for silicon photonic device design and optimization. We utilized moderate swarm population and iteration cycle. It is possible that even better device geometry will emerge with more dedicated optimization. This design method can be readily used address other challenges such as non-uniform grating couplers and distributed brag gratings (DBRs).

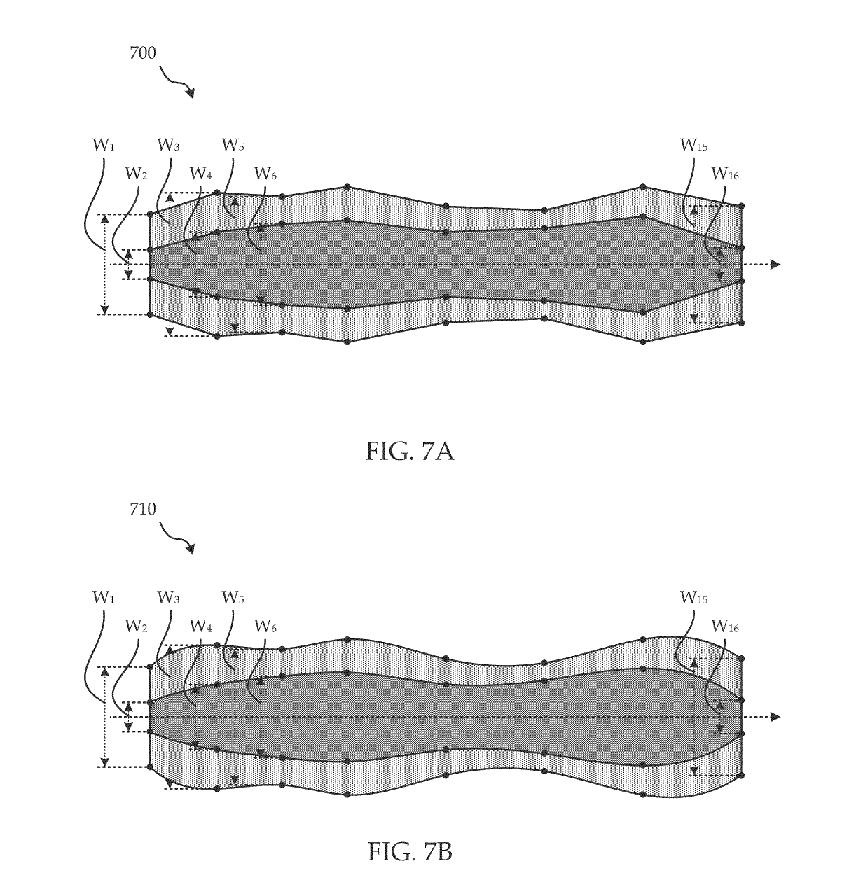

With reference to FIG. 6 the method described above for use in designing photonic devices will now be described. The process is divided into two main phases, initial design generally indicated by Roman numeral “I”, and optimization generally indicated by Roman numeral “II”.

The initial design phase I of the method depicted in FIG. 6 will first be described.

In accordance with that described hereinabove, fabrication processes for integrated photonic devices have limitations and design rules which are defined by their nature. For example, as discussed above, typical CMOS photonic processes commonly use 193 nm or 248 nm steppers. The method of designing and fabricating photonic devices therefore includes a step of identifying the fabrication design rules 600 which are used to constrain various aspects of the design and more particularly to constrain all of the steps of the method including the smoothing and modifying steps described below. Such design rules may take such forms as minimum feature size or minimum line width. As described hereinabove, in the context of the Y-junction, a minimum feature size of 200 nm is assumed during the design (for a 248 nm CMOS), which will not break the designs rules, and which helps to ensure yield.

As described hereinabove, an initial design is created which uses judiciously chosen input and output (I/O) ports 610 having widths so as to remain within the constraints of the fabrication design rules.

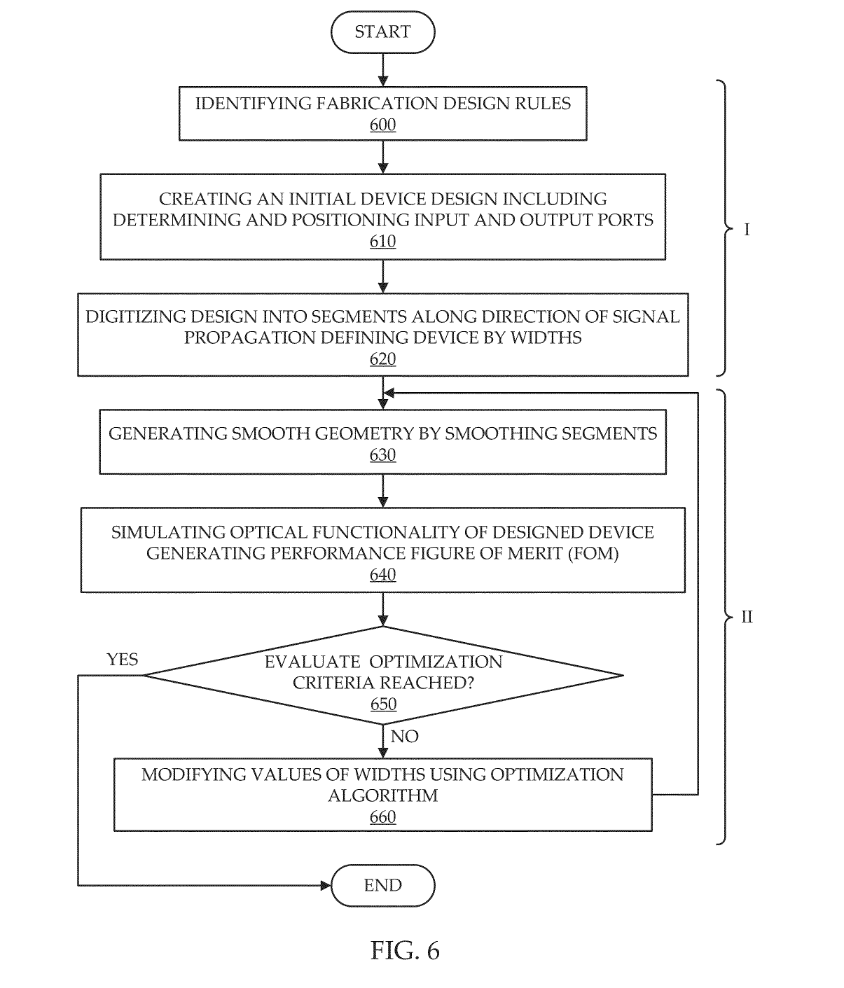

The initial device design is then divided or digitized 620 into segments along the direction of propagation of the optical signal and characterized by widths W_{I} defined along the length of the device, for example as depicted in FIG. 1A and FIG. 7A.

It should be noted that characterizing the design in this way, by widths of segments which are along the direction of the propagation of the optical signal, helps to ensure a smooth and manufacturable geometry, that fabrication design rules will not be broken, and that small differences between the resulting fabrication and the optimized design will not lead to major differences in function or performance between the two. Known methods in which optimization algorithms operate on and generate arbitrary 2d and 3d mesh designs can lead to pathological and/or discontinuous solutions having multiple voids and islands or overcomplicated boundaries. The functionality and performance of those kinds of devices are very sensitive to any small and necessarily unpredictable deviation in fabrication, leading to high risk and low yields.

It also should be noted that relatively economical parameterization of the PIC device in terms of widths leads to simpler and more efficient design and optimization.

The optimization phase II of the method depicted in FIG. 6 will now be described. It should be noted that the main steps of optimization including smoothing, simulating, evaluation, and modifying may be carried out in other orders and/or included in as a first pass in the initial design phase I described above. Skilled persons in the art will understand which minor variations to the order and number of times the steps of FIG. 6 are carried out that will constitute unsubstantial deviation from the general method taught herein.

For any given design defined by widths, prior to simulating device functionality and particularly the electromagnetic response for frequencies of interest, the geometry of the design is smoothed. This does not imply variation of the widths or the points along the edges of the device design which define them, but a shaping of the curves passing through them as depicted in FIG. 1A and FIG. 7B. As such, in the method, the generating of smooth geometry by smoothing segments 630 constitutes smooth curve interpolation, which as described above in the context of the Y-junction comprises spline interpolation of the geometry between the points defined by the widths. The smoothing of the geometry improves the accuracy of the simulation in reference to the design in that an actual fabricated device resulting from the design, due to the particular nature of the fabrication process, will not comprise perfectly straight lines defining its segments but will comprise a smooth curve. More sophisticated methods of smoothing than spline interpolation which take into account the UV lithographic photonic processes actually used are utilized in some embodiments. In some embodiments generating the smoothed geometry of the device design utilizes optical proximity correction (OPC) and/or device fabrication simulation to generate an accurate prediction of the resulting device structure which would result from the device design and the fabrication process.

As described hereinabove the smoothed geometry is subjected to a simulation to determine the electromagnetic response of the device which generates at least one figure of merit (FOM) 640 which is used to determine whether optimization is complete. Depending upon the particular photonic device being designed and fabricated, the figure of merit can take on whatever desirable functionality, result, and/or response of the device that is appropriate in context. In the case of the Y-junction described hereinabove, the simulation method comprises use of the finite difference time domain (FDTD) method, and generating the at least one FOM comprises determining the power in the TE0 mode at either branch. In addition to FDTD in some embodiments, photonic simulation methods used include beam propagation, eigenmode expansion, and any other known appropriate method of simulating the electromagnetic response of the device.

After simulating the smoothed device, the method has a step of evaluation to determine if optimization criteria are met 650. The optimization criteria comprise one or more of some absolute value or values for the FOM, a measure of convergence of the FOM from iteration to iteration, a number of iterations of optimization has been reached, and some other appropriately chosen optimization criteria. In any case, the optimization criteria are chosen to facilitate optimization of the device to desired levels of performance or otherwise determine that optimization should be ended. As described hereinabove, the optimization criteria for a Y-junction can be chosen to be 50 iterations or achievement of sub-0.2 dB insertion loss. For the initial design often the optimization criteria are not met, and usually the optimization steps of smoothing, evaluation, and design modification are iteratively performed multiple times. If the optimization criteria are met the optimization phase II comes to an end as does the method depicted in FIG. 6, the result being the final design including the values of the widths last modified, as described below, using an optimization algorithm, the final design of which is utilized for fabrication of the device.

If the optimization criteria are not reached, the method proceeds to the step of modifying values of widths using an optimization algorithm 660. Each of the widths W_{I} characterizing the device and defining the device design are modified according to an optimization algorithm which serves to search the parameter space of possible widths W_{I} in a manner which optimizes the device according to the FOM. In some embodiments the optimization algorithm comprises a genetic algorithm, whereas in other embodiments, such as the one described hereinabove in connection with the Y-junction, the optimization algorithm comprises particle swarm optimization. Various other optimization algorithms are known to skilled persons in the art and can, for example, comprise a heuristic algorithm. The goal of modifying the various widths is that the FOM are improved and hence the performance of the device is optimized.

In accordance with FIG. 6 and as described hereinabove, each iteration of optimization phase II generally includes modification of the widths W_{I}, generation of a smooth geometry based thereon, simulation of the device to determine FOM, and evaluation to determine whether optimization criteria have been met.

As described hereinabove, the result of the method of FIG. 6 is a device design defined by the widths W_{I} emerging from the optimization phase II as meeting the optimization criteria. This final device design is used in the fabrication process to fabricate the device. Due to the identification of and adherence to the design rules which the anticipated fabrication process impose upon the design, at every step of the method, including the initial design, smoothing, and modifying steps, the final design will tend to show high yield of manufacturability and predictably exhibit the anticipated functionality and performance as predicted by the simulation.

As depicted in FIG. 7A and FIG. 7B, a device design 700 according to one embodiment includes a layout which has segments defined by multiple widths, as in the case when there are multiple materials utilized in the structure. In FIG. 7A, for example, a first material is located at a core of the device and is defined by widths W2, W4, W6, . . . , W16, whereas a second material surrounds the first material and is defined by widths W1, W3, W5, . . . , W15. FIG. 7A depicts a straight-line geometry resulting from straight-line interpolation between points defined by the widths W_{I}. In some embodiments, the first and second materials have different thicknesses.

FIG. 7B serves as a good illustration of spline interpolation of the geometry of the device 710 passing through the points defined by the widths W_{I}.

Although the above description of a method of designing an integrated optical device has been illustrated with a device formed in one or more materials in a single layer, skilled persons in the art will understand that the method is equally applicable to forming devices having multiple layers, each of which may have multiple materials or have different thicknesses from other layers.

### Optical Waveguides and their Uses

We have described various optical waveguide systems and application, as well as fabrication techniques for such waveguides in a number of patent documents, including U.S. Pat. Nos. 7,200,308, 7,424,192, 7,480,434, 7,643,714, and 7,760,970.

### DEFINITIONS

Unless otherwise explicitly recited herein, any reference to an electronic signal or an electromagnetic signal (or their equivalents) is to be understood as referring to a non-volatile electronic signal or a non-volatile electromagnetic signal.

Recording the results from an operation or data acquisition, such as for example, recording results at a particular frequency or wavelength is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method of designing a photonic device, the method comprising:
identifying fabrication design rules of a fabrication process;
generating an initial device design by determining, with use of constraints of the fabrication design rules, a plurality of I/O ports and segments along a direction of optical signal propagation, each segment of the plurality of segments characterized by at least one width, at least one of the segments characterized by at least two widths; and
iteratively optimizing a device design starting with the initial device design by:
generating a smoothed geometry of the device design;
simulating a functionality of the device utilizing the smoothed geometry of the device design; and
utilizing an optimization algorithm on said widths characterizing said segments.

2. A method according to claim 1 wherein generating the smoothed geometry of the device design comprises spline interpolation.

3. A method according to claim 1 wherein iteratively optimizing the device design is performed in accordance with the fabrication design rules.

4. A method according to claim 3 wherein the fabrication design rules comprise a minimum feature size.

5. A method according to claim 3 wherein the fabrication design rules comprise a minimum feature size substantially equal to 200 nm.

6. A method according to claim 1 wherein the optimization algorithm comprises at least one of a particle swarm optimization algorithm and a genetic algorithm.

7. A method according to claim 6 wherein simulating a functionality of the device comprises determining at least one figure of merit (FOM), wherein iteratively optimizing the device design comprises evaluating optimization criteria with use of the at least one FOM, and for each iteration of said iteratively optimizing for which optimization criteria has not been met, modifying at least one of said widths characterizing said segments according to the optimization algorithm.

8. A method according to claim 7 wherein simulating a functionality of the device comprises simulating the electromagnetic response of the device using at least one of a finite difference time domain (FDTD) method, beam propagation, and eigenmode expansion.

9. A method according to claim 1 wherein a first width of each of the at least two widths defines a width of a core material, and a second width of each of the at least two widths defines a width of a material surrounding the core material.

10. A method according to claim 9 wherein generating the smoothed geometry of the device design comprises spline interpolation applied to geometries of each of the two materials.

11. A method according to claim 1 wherein generating the smoothed geometry of the device design comprises performing at least one of optical proximity correction and device fabrication simulation.

12. A method of designing a photonic device, the method comprising:
identifying fabrication design rules of a fabrication process;
generating an initial device design by determining, with use of constraints of the fabrication design rules, a plurality of I/O ports and segments along a direction of optical signal propagation, each segment of the plurality of segments characterized by at least one width; and
iteratively optimizing a device design starting with the initial device design by:
generating a smoothed geometry of the device design with use of at least one of optical proximity correction and device fabrication simulation;
simulating a functionality of the device utilizing the smoothed geometry of the device design; and
utilizing an optimization algorithm on said widths characterizing said segments.

13. A method according to claim 12 wherein generating the smoothed geometry of the device design comprises spline interpolation.

14. A method according to claim 12 wherein iteratively optimizing the device design is performed in accordance with the fabrication design rules.

15. A method according to claim 14 wherein the fabrication design rules comprise a minimum feature size.

16. A method according to claim 14 wherein the fabrication design rules comprise a minimum feature size substantially equal to 200 nm.

17. A method according to claim 12 wherein the optimization algorithm comprises at least one of a particle swarm optimization algorithm and a genetic algorithm.

18. A method according to claim 12 wherein simulating a functionality of the device comprises determining at least one figure of merit (FOM), wherein iteratively optimizing the device design comprises evaluating optimization criteria with use of the at least one FOM, and for each iteration of said iteratively optimizing for which optimization criteria has not been met, modifying at least one of said widths characterizing said segments according to the optimization algorithm.

19. A method according to claim 18 wherein simulating a functionality of the device comprises simulating the electromagnetic response of the device using at least one of a finite difference time domain (FDTD) method, beam propagation, and eigenmode expansion.
